(19) United States
(12) Patent Application Publication
(10) Pub. No.: US 2025/0187650 A1
(43) Pub. Date: Jun. 12, 2025

(54) STEERING APPARATUS FOR VEHICLE

(71) Applicant: HYUNDAI MOBIS CO., LTD., Seoul (KR)

(72) Inventor: Kyung Heun KIM, Yongin-si (KR)

(73) Assignee: HYUNDAI MOBIS CO., LTD., Seoul (KR)

(21) Appl. No.: 18/802,347

(22) Filed: Aug. 13, 2024

(30) Foreign Application Priority Data
Dec. 6, 2023 (KR) 10-2023-0175588

(51) Int. Cl. B62D 5/04; F16H 55/24

(52) U.S. Cl. CPC B62D 5/0409; B62D 5/0403; F16H 55/24

(57) ABSTRACT

A steering apparatus for a vehicle according to the present disclosure includes a housing, a worm wheel accommodated within the housing and mounted on a steering shaft, a worm shaft that rotates by being engaged with the worm wheel, a bearing mounted on the worm shaft, and a damper that rotatably surrounds the bearing, comes into contact with an inner surface of the housing, and provides an elastic force to the worm shaft towards a worm wheel side.

### CROSS-REFERENCE TO RELATED APPLICATION

The present application claims priority to and the benefit of Korean Patent Application No. 10-2023-0175588, filed on Dec. 6, 2023 in the Korean Intellectual Property Office, the entire disclosure of which is incorporated herein by reference.

### BACKGROUND

### Field

Exemplary embodiments of the present disclosure relate to a steering apparatus for a vehicle, and more specifically, to a steering apparatus for a vehicle, which can restrict a tilting of a worm shaft and prevent movement thereof.

### Description of the Related Art

In a conventional steering apparatus for a vehicle, a bottom bearing is configured to a spring, a sliding damper, an end cover assembly so as to compensate for rotation and a tilting of a worm shaft when a worm shaft and a worm wheel are driven. An axial distance between the worm wheel and the worm shaft fails to be maintained constant, and thus the worm shaft is tilted depending on a pressure angle while the worm shaft rotates. The tilting of the worm shaft increases rattle noise and friction and causes to occur noise when the worm shaft is tilted beyond a target tilting amount. Accordingly, there is a demand for improving this.

The background technology of the present disclosure is disclosed in Korean Patent Publication No. 10-2261787 (registered on Jun. 1, 2021 and entitled “STEERING APPARATUS FOR VEHICLE”).

### SUMMARY

Various embodiments of the present disclosure are directed to providing a steering apparatus for a vehicle, which may restrict a tilting of a worm shaft and prevent movement thereof.

A steering apparatus for a vehicle according to the present disclosure may include a housing, a worm wheel accommodated within the housing and mounted on a steering shaft, a worm shaft that rotates by being engaged with the worm wheel, a bearing mounted on the worm shaft, and a damper that rotatably surrounds the bearing, comes into contact with an inner surface of the housing, and provides an elastic force to the worm shaft towards a worm wheel side.

The damper may include a cover that closes the opened housing and an elastic part that is configured so that a first side of the elastic part is mounted on the cover and a second side of the elastic part rotatably surrounds the bearing, comes into contact with the inner surface of the housing, and elastically pressurizes the worm shaft towards the worm wheel side.

The elastic part may include an elastic deformation part that is configured so that a first side of the elastic deformation part is mounted on the cover and a second side of the elastic deformation part rotatably surrounds the bearing and includes an elastically deformable material, and a leaf spring that is mounted on the elastic deformation part and provides an elastic force to the bearing when the elastic deformation part is elastically deformed by the tilting of the worm shaft.

The elastic deformation part may include an elastic deformation body part that is mounted on the cover and formed in a circular shape, elastic side support parts that are formed to protrude from first and second sides of an inner surface of the elastic deformation body part, respectively and support the leaf spring, an elastic lower support part that is formed to protrude from a lower side of the inner surface of the elastic deformation body part and supports the bearing, and an elastic upper support part that is formed to protrude from an upper side of the inner surface of the elastic deformation body part and adjusts a tilting amount of the worm shaft by providing the elastic force when in contact with the bearing.

The elastic upper support may be formed to protrude from the upper side of the inner surface of the elastic deformation body part so as to be spaced apart at a predetermined distance from the leaf spring.

The elastic upper support part may be formed to protrude in a hollow shape from the upper side of the inner surface of the elastic deformation body part.

The elastic side support part may include elastic side contact parts that are formed to protrude each pair from first and second sides of the inner surface of the elastic deformation body part, respectively and come into contact with the leaf spring, and an elastic side stopper part that is fixed to the elastic deformation body part and is disposed between a pair of the elastic side contact parts.

The elastic lower support part may include an elastic lower support part that is formed to protrude from the lower side of the inner surface of the elastic deformation body part and an elastic lower contact part that is vertically connected to an end portion of the elastic lower support part and comes into contact with the bearing.

The elastic deformation part may further include an elastic stopper part that is mounted on the elastic deformation body part, is disposed on an inner of the leaf spring and prevents the leaf spring from detaching therefrom when moving towards the worm shaft side by the elastic upper support part.

The cover may include a cover body part that closes the opened housing and a cover support part that is formed to protrude from the cover body part along a circumferential direction of the cover body part and mounts the elastic part thereon.

The steering apparatus for the vehicle according to the present disclosure may easily manage the tilting of the worm shaft by the damper.

Furthermore, according to the present disclosure, the number of parts may be decreased and an assembly processing may be reduced by adjusting the tilting of the worm shaft by one damper, so that manufacturing costs may be saved and productivity may be improved.

### BRIEF DESCRIPTION OF THE DRAWINGS

FIG. 1 is a perspective view schematically illustrating a steering apparatus for a vehicle according to an embodiment of the present disclosure.

FIG. 2 is an assembled perspective view schematically illustrating the steering apparatus for the vehicle according to an embodiment of the present disclosure.

FIG. 3 is a perspective view schematically illustrating a damper according to an embodiment of the present disclosure.

FIG. 4 is an assembled perspective view schematically illustrating the damper according to an embodiment of the present disclosure.

FIG. 5 is a perspective view schematically illustrating the main configuration of the steering apparatus for the vehicle according to an embodiment of the present disclosure.

FIG. 6 is a side view schematically illustrating the main configuration of the steering apparatus for the vehicle according to an embodiment of the present disclosure.

FIG. 7 is a perspective view schematically illustrating an operation of the main configuration of the steering apparatus for the vehicle according to an embodiment of the present disclosure.

FIG. 8 is a side view schematically illustrating the operation of the main configuration of the steering apparatus for the vehicle according to an embodiment of the present disclosure.

### DETAILED DESCRIPTION

Hereinafter, a steering apparatus for a vehicle according to embodiments of the present disclosure will be described with reference to the accompanying drawings. In this process, the thickness of lines or the sizes of components illustrated in the drawings may have been exaggerated for the clarity of a description and for convenience' sake.

Furthermore, terms to be described below have been defined by taking into consideration their functions in the present disclosure, and may be changed depending on a user or operator's intention or practice. Accordingly, such terms should be defined based on the overall contents of this specification.

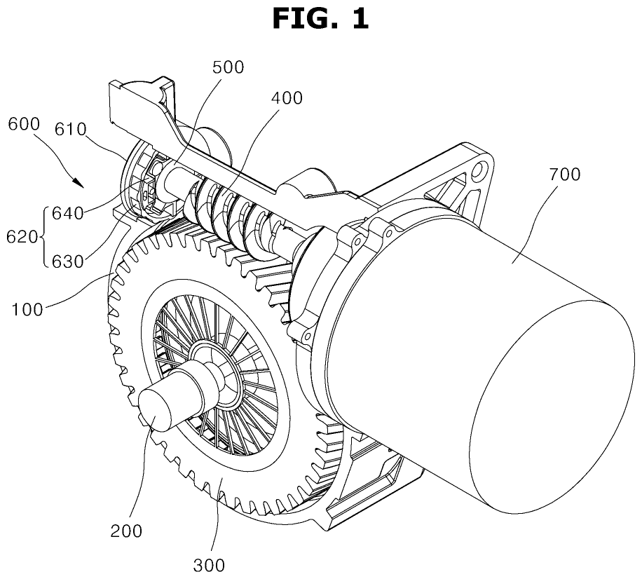

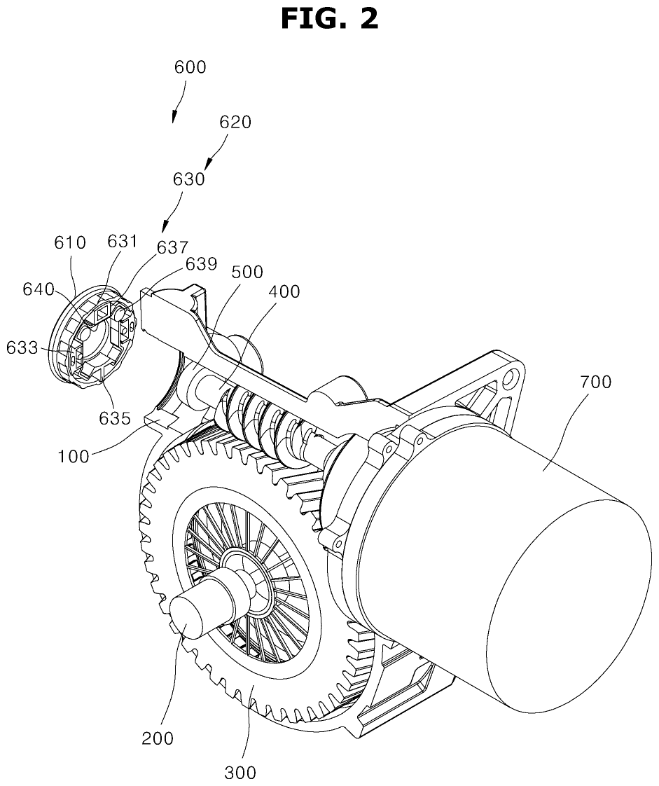

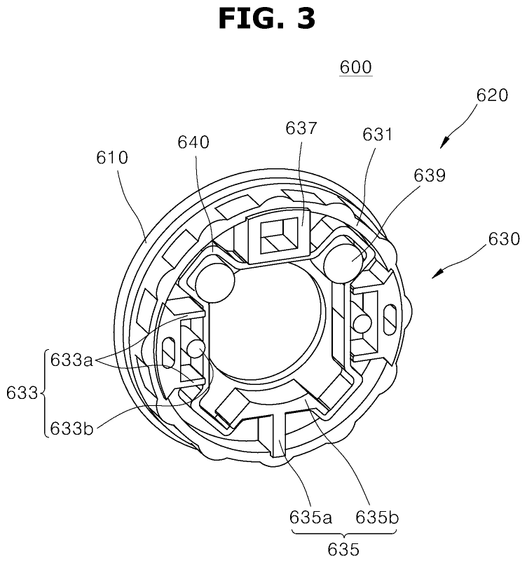

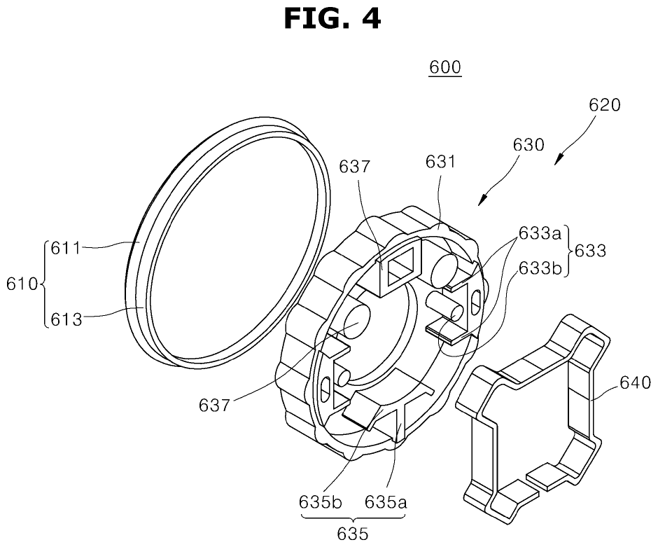

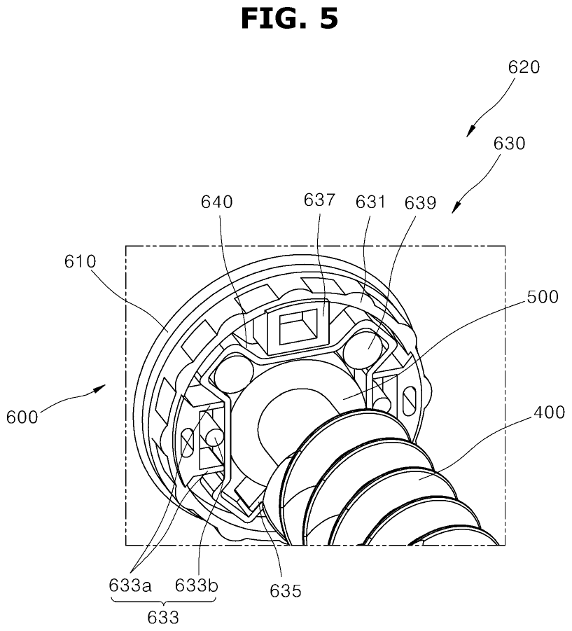

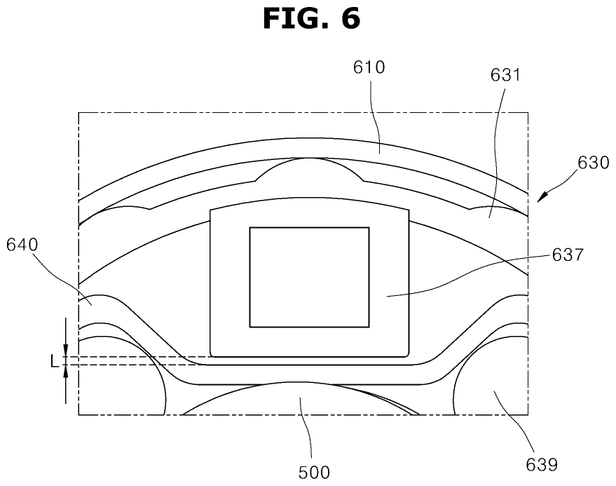

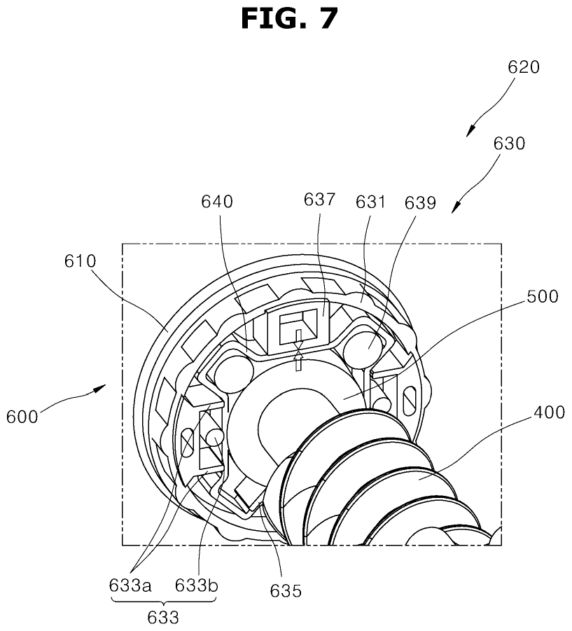

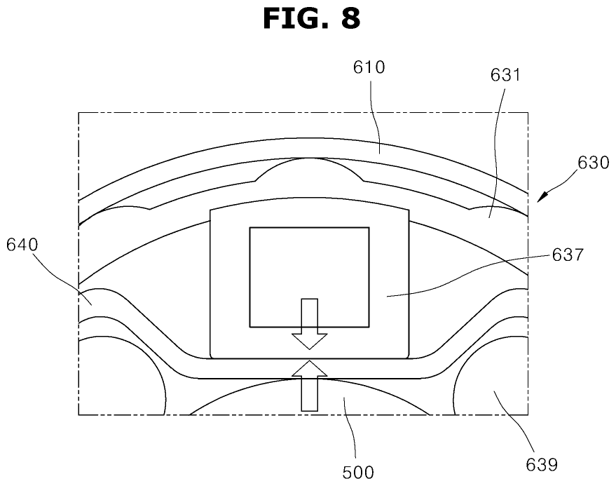

FIG. 1 is a perspective view schematically illustrating a steering apparatus for a vehicle according to an embodiment of the present disclosure, FIG. 2 is an assembled perspective view schematically illustrating the steering apparatus for the vehicle according to an embodiment of the present disclosure, FIG. 3 is a perspective view schematically illustrating a damper according to an embodiment of the present disclosure, FIG. 4 is an assembled perspective view schematically illustrating the damper according to an embodiment of the present disclosure, FIG. 5 is a perspective view schematically illustrating the main configuration of the steering apparatus for the vehicle according to an embodiment of the present disclosure, FIG. 6 is a side view schematically illustrating the main configuration of the steering apparatus for the vehicle according to an embodiment of the present disclosure, FIG. 7 is a perspective view schematically illustrating an operation of the main configuration of the steering apparatus for the vehicle according to an embodiment of the present disclosure, and FIG. 8 is a side view schematically illustrating the operation of the main configuration of the steering apparatus for the vehicle according to an embodiment of the present disclosure.

Referring to FIGS. 1 to 8, the steering apparatus for the vehicle according to an embodiment of the present disclosure may include a housing 100, a steering shaft 200, a worm wheel 300, a worm shaft 400, a bearing 500, and a damper 600.

The steering shaft 200, the worm wheel 300, the worm shaft 400, the bearing 500, and the damper 600 may be mounted on an inner space of the housing 100. One side (the left side of FIGS. 1 and 2) of the housing 100 is formed to be opened, and the damper 600 may be mounted on the opened housing 100.

The steering shaft 200 may be connected to a steering wheel of the vehicle. The worm wheel 300 may be accommodated in the inner space of the housing 100 and be mounted on the steering shaft 200.

The worm shaft 400 may rotate by being engaged with the worm wheel 300. The worm shaft 400 that rotates together by being engaged with the worm wheel 300, may be connected to a motor 700 through a shaft. The motor 700 may be connected to a first side (the right side of FIG. 1) of the worm shaft 400 and the bearing 500 that is formed in a ring shape, be mounted on a second side (the left side of FIG. 1) of the worm shaft 400.

The bearing 500 may be mounted on an end portion (the left end portion of FIG. 1) of the worm shaft 400. The bearing 500 that is mounted on the end portion of the worm shaft 400, may rotatably support the worm shaft 400 and reduce friction generated when the worm shaft 400 rotates.

The damper 600 may rotatably surround the bearing 500, come into contact with an inner surface of the housing 100, and elastically pressurize the worm shaft 400 towards the worm wheel 300 side (the lower of FIG. 1). The damper 600 may elastically pressurize the worm shaft 400 towards the worm wheel 300, so that a tilting of the worm shaft 400 may be prevented or decreased.

The damper 600 may include a cover 610 and an elastic part 620. The cover 610 may close one side (the left side of FIG. 1) of the opened housing 100. The cover 610 may close the opened housing 100, so as to prevent a foreign material from flowing into the housing 100.

The cover 610 may include a cover body part 611 and a cover support part 613. The cover body part 611 may close one side (the left side of FIG. 1) of the opened housing. The cover support part 613 may be formed to protrude from the cover body part 611 along a circumferential direction of the cover body part 611 and the elastic part 620 may be mounted thereon. The cover support part 613 may be coupled with the elastic part 620 by a bonding method.

The cover 610 may be made of an elastically deformable material. The cover 610 may be made of an elastically deformable material and be easily mounted on the housing 100, so as to prevent a foreign material from flowing thereinto by filling a gap of the housing 100. The cover 610 may be made of an elastically deformable material, such as rubber, silicone, or urethane.

The elastic part 620 may be configured so that a first side (the left side of FIG. 2) of the elastic part 620 is mounted on the cover 610 and a second side (the right side of FIG. 2) of the elastic part 620 rotatably surrounds the bearing 500. The elastic part 620 may come into contact with the inner surface of the housing 100 and provide an elastic force to the worm shaft 400 towards the worm wheel 300 side. When the worm shaft 400 is tilted, the elastic part 620 may elastically pressurize the worm shaft 400 towards the worm wheel side by providing the elastic force to the worm shaft 400 mounted on the bearing 500.

The elastic part 620 may include an elastic deformation part 630 and a leaf spring 640. The elastic deformation part 630 may be configured so that a first side (the left side of FIG. 2) of the elastic deformation part 630 is mounted on the cover 610 and a second side (the right side of FIG. 2) of the elastic deformation part 630 rotatably surrounds the bearing 500, and is made of an elastically deformable material. The leaf spring 640 may be mounted on the elastic deformation part 630. The elastic deformation part 630 may elastically pressurize the worm shaft 400 towards the worm wheel 300 side while elastically being deformed along with the leaf spring 640.

Referring to FIGS. 3 to 4, the elastic deformation part 630 may include an elastic deformation body part 631, an elastic side support part 633, an elastic lower support part 635, and an elastic upper support part 637.

The elastic deformation body part 631 may be mounted on the cover 610 and be formed in a circular shape. The elastic deformation body part 631 may be coupled with the cover support part 613 of the cover 610 by a bonding method. The bearing 500 may be mounted on a center of the elastic deformation body part 631.

The elastic side support parts 633 may be formed to protrude from both sides of an inner surface of the elastic deformation body part 631, respectively and support the leaf spring 640. The elastic side support part 633 may include elastic side contact parts 633a and an elastic side stopper part 633b.

The elastic side contact parts 633a may be formed to protrude a pair from both sides of the inner surface of the elastic deformation body part 631, respectively and come into contact with the leaf spring 640. In addition, the elastic side contact parts 633a may be formed to protrude in a hollow square shape from both sides of the inner surface of the elastic deformation body part 631, respectively.

The elastic side stopper part 633b may be fixed to the elastic deformation body part 631 and be disposed between a pair of the elastic side contact parts 633a. The elastic side stopper part 633b may be fixed to the elastic deformation body part 631 in a cylindrical shape. The elastic side stopper part 633b may be disposed to come into contact with or be spaced apart from the leaf spring 640. The elastic side stopper part 633b may prevent the leaf spring 640 that is elastically deformed by assisting the elastic side contact parts 633a, from being detached therefrom.

The elastic lower support part 635 may be formed to protrude from a lower side of the inner surface of the elastic deformation body part 631 and support the bearing 500. The elastic lower support part 635 may be formed to protrude from the lower side of the inner surface of the elastic deformation body part 631 towards an upper side thereof.

The elastic lower support part 635 may include an elastic lower support body part 635a and an elastic lower contact part 635b. The elastic lower support body part 635a may be formed to protrude from the lower side of the inner surface of the elastic deformation body part 631 in a direction of an upper side thereof towards the bearing 500. The elastic lower support body part 635a may be formed to protrude in a linear shape from the lower side of the inner surface of the elastic deformation body part 631.

The elastic lower contact part 635b is vertically disposed to an end portion (the upper portion of FIG. 3) of the elastic lower support body part 635a and may come into contact with the bearing 500. The elastic lower contact part 635b may be configured so that a lower surface thereof comes into contact with the leaf spring 640 and an upper surface thereof comes into contact with the bearing 500. The upper surface of the elastic lower contact part 635b in contact with the bearing 500 may be formed in a curved shape corresponding to a shape of the bearing 500.

The elastic upper support part 637 may be formed to protrude from an upper side of the inner surface of the elastic deformation body part 631 and adjust a tilting amount of the worm shaft 400 by providing an elastic force when in contact with the bearing part 500.

The elastic upper support part 637 may adjust the tilting amount of the worm shaft 400 by adjusting a predetermined distance L spaced apart from the leaf spring 640 or the bearing part 500.

The elastic upper support part 637 may be formed to protrude from the upper side of the inner surface of the elastic deformation body part 631 so as to be spaced apart at the predetermined distance L from the leaf spring 640.

The tilting amount of the worm shaft 400 may increase as the predetermined distance L spaced apart between the elastic upper support part 637 and the leaf spring 640 is getting farther and the tilting amount of the worm shaft 400 may decrease as the predetermined distance L spaced apart between the elastic upper support part 637 and the bearing 500 is getting closer.

The elastic upper support part 637 may be formed to protrude in a hollow shape from the upper side of the inner surface of the elastic deformation body part 631. The elastic upper support part 637 that is formed in a hollow shape, may be elastically deformed by contact with the leaf spring 640 or the bearing 500 and provide an elastic force (or an elastic restoring force) when being released a contact therewith. The elastic upper support part 637 may be formed in a hollow square shape.

The elastic deformation part 630 may further include an elastic stopper part 639. The elastic stopper part 639 may be mounted on the elastic deformation body part 631. The elastic stopper part 639 that is formed in a cylindrical shape, may be mounted on the elastic deformation body part 631.

The elastic stopper part 639 is disposed at an inner of the leaf spring 640 and when the leaf spring 640 moves towards the worm shaft 400 side (the lower side of FIG. 5) by the elastic upper support part 637, may prevent the leaf spring 640 from detaching therefrom. That is, when moving towards the worm shaft 400 side by the elastic upper support part 637, the leaf spring 640 may be prevented from detaching from the elastic deformation body part 631 by being caught by the elastic stopper part 639.

The elastic deformation part 630 may be made of an elastically deformable material. The elastic deformation part 630 may be made of an elastically deformable material, such as rubber, silicone, or urethane.

The leaf spring 640 may be mounted on the elastic deformation part 630 and provide an elastic force to the bearing 500 when the elastic deformation part 630 is elastically deformed by the tilting of the worm shaft 400. The leaf spring 640 may be made of metal or glass fiber reinforced plastic (GFRP).

One side (the lower side of FIG. 4) of the leaf spring 640 may be formed to be opened, and the opened leaf spring 640 may be mounted on the elastic lower support body part 635a of the elastic lower support part 635.

The leaf spring 640 may be configured so that a side surface thereof is supported by the elastic side support part 633, a lower side thereof is supported by the elastic lower support part 635, and an upper side thereof comes into contact with the elastic upper support part 637. The elastic stopper part 639 may be disposed to the inner of the leaf spring 640.

Referring to FIGS. 5 to 8, it will be disclosed that the steering apparatus for the vehicle according to an embodiment of the present disclosure adjusts the tilting of the worm shaft 400.

The elastic upper support part 637 of the elastic deformation part 630 may adjust the tilting amount of the worm shaft 400 by adjusting the set length L spaced apart from the leaf spring 640 or the bearing 500.

More specifically, it may be desirable to adjust the predetermined distance L spaced apart between the elastic upper support part 637 and the leaf spring 640.

The tilting amount of the worm shaft 400 may be adjusted to increase as the predetermined distance L spaced apart between the elastic upper support part 637 and the leaf spring 640 is getting farther, and to decrease as the predetermined distance L spaced apart between the elastic upper support part 637 and the bearing 500 is getting closer.

The steering apparatus for the vehicle according to an embodiment of the present disclosure may easily manage the tilting of the worm shaft 400 by the damper 600.

Furthermore, according to the present disclosure, the number of parts may be decreased and an assembly processing may be reduced by adjusting the tilting of the worm shaft 400 by one damper 600, so that manufacturing costs may be saved and productivity may be improved.

Although the specific embodiments of the present disclosure have been described until now, the spirit and scope of the present disclosure are not limited to the specific embodiments, and may be variously corrected and modified by an ordinary person in the art, to which the present disclosure pertains, without changing the essence of the present disclosure claimed in the claims.

What is claimed is:

1. A steering apparatus for a vehicle, the steering apparatus comprising:
a housing having an open end portion; and
a worm wheel accommodated within the housing and mounted on a steering shaft;
a worm shaft engaged with the worm wheel and configured to rotate by an actuator;
a bearing mounted on the worm shaft; and
a damper that rotatably surrounds the bearing, comes into contact with an inner surface of the housing, and provides an elastic force to the worm shaft towards a worm wheel side.

2. The steering apparatus of claim 1, wherein the damper includes:
a cover that closes the open end portion of the housing; and
an elastic part that is configured so that a first side of the elastic part is mounted on the cover and a second side of the elastic part rotatably surrounds the bearing,
wherein the elastic part comes into contact with the inner surface of the housing, and elastically pressurizes the worm shaft towards the worm wheel side.

3. The steering apparatus of claim 2, wherein the elastic part includes:
an elastic deformation part that is configured so that a first side of the elastic deformation part is mounted on the cover and a second side of the elastic deformation part rotatably surrounds the bearing, and includes an elastically deformable material; and
a leaf spring that is mounted on the elastic deformation part and provides the elastic force to the bearing in response that the elastic deformation part is elastically deformed by a tilting of the worm shaft.

4. The steering apparatus of claim 3, wherein the elastic deformation part includes:
an elastic deformation body part that is mounted on the cover and is formed in a circular shape;
elastic side support parts that are formed to protrude from first and second sides of an inner surface of the elastic deformation body part, respectively and support the leaf spring;
an elastic lower support part that is formed to protrude from a lower side of the inner surface of the elastic deformation body part and supports the bearing; and
an elastic upper support part that is formed to protrude from an upper side of the inner surface of the elastic deformation body part and adjusts a tilting amount of the worm shaft by providing an elastic force when in contact with the bearing.

5. The steering apparatus of claim 4, wherein the elastic upper support part is formed to protrude from the upper side of the inner surface of the elastic deformation body part so as to be spaced apart at a predetermined distance from the leaf spring.

6. The steering apparatus of claim 4, wherein the elastic upper support part is formed to protrude in a hollow shape from the upper side of the inner surface of the elastic deformation body part.

7. The steering apparatus of claim 4, wherein the elastic upper support part is disposed outside the leaf spring in the elastic deformation body part.

8. The steering apparatus of claim 4, wherein the elastic side support part includes:
elastic side contact parts that are formed to protrude each pair from the first and second sides of the inner surface of the elastic deformation body part, respectively and come into contact with the leaf spring; and
an elastic side stopper part that is fixed to the elastic deformation body part and is disposed between a pair of the elastic side contact parts.

9. The steering apparatus of claim 4, wherein the elastic side support part is disposed outside the leaf spring in the elastic deformation body part.

10. The steering apparatus of claim 4, wherein the elastic lower support body part includes:
an elastic lower support body part that is formed to protrude from the lower side of the inner surface of the elastic deformation body part; and
an elastic lower contact part that is vertically connected to an end portion of the elastic lower support part and comes into contact with the bearing.

11. The steering apparatus of claim 10, wherein a first end of the leaf spring is engaged to a first end of the elastic lower contact part and a second end of the leaf spring is engaged to a second end of the elastic lower contact part.

12. The steering apparatus of claim 4, wherein the elastic deformation part further includes an elastic stopper part that is mounted on the elastic deformation body part, disposed on an inner of the leaf spring and prevents the leaf spring from detaching therefrom when moving towards the worm shaft side by the elastic upper support part.

13. The steering apparatus of claim 2, wherein the cover includes:
a cover body part that closes the open portion of the housing; and
a cover support part that is formed to protrude from the cover body part along a circumferential direction of the cover body part and mounts the elastic part on the cover support part.
